(19) United States
(12) Patent Application Publication
(10) Pub. No.: US 2022/0129795 A1
(43) Pub. Date: Apr. 28, 2022

(54) SYSTEMS AND METHODS FOR COGNITIVE INFORMATION MINING

(71) Applicant: Larsen & Toubro Infotech Ltd, Mumbai (IN)

(72) Inventors: Sanchit Mehrotra, Pune (IN); Aamir Shaikh, Navi Mumbai (IN); Aayushi Agarwal, Mumbai (IN); Anoop Singh, Pune (IN); Bhushan Bobhate, Pune (IN); Dubey Deepak Kumar, Pune (IN); K Nitin Patil, Pune (IN); Pranav Patil, Pune (IN); Sachin Vyas, Pune (IN); Satish Saluja, Pune (IN)

(73) Assignee: Larsen & Toubro Infotech Ltd, Mumbai (IN)

(21) Appl. No.: 17/214,754

(22) Filed: Mar. 26, 2021

(30) Foreign Application Priority Data
Oct. 23, 2020 (IN) 202021046217

(51) Int. Cl. G06N 20/20; G06N 5/02; G06K 9/62; G06K 9/00

(52) U.S. Cl. CPC G06N 20/20; G06K 9/00456; G06K 9/6263; G06N 5/025

(57) ABSTRACT

Systems and methods for cognitive information mining are provided. A cognitive information extraction system provides intelligent information extraction from documents in different formats, types and forms. Since a huge portion of the data and information is still stored in unstructured documents in physical format, the system provides for a framework to extract information from such documents. Further, even in the digital form, the documents are available in multiple different formats, which can act as a great hindrance to useful extract information. The invention focuses upon mitigating this scenario by combining multiple AI models and modules to create a framework for document processing and human-machine interaction for training and QC verification, wherein the framework provides user the flexibility to work upon multiple types of documents, and also ensures that accuracy is maintained while the information is being extracted. The framework is further capable of continuously updating and creating advanced versions by an automated feedback system.

### TECHNICAL FIELD OF THE DISCLOSURE

The present disclosure relates to a system and method for automatic cognitive extraction of relevant information from a set of documents. The disclosure provides a method and a system for automated information extraction using various cognitive engines which are built using advance Artificial Intelligence (AI) techniques to extract various entities from diverse data sources e.g. scanned physical paper document, simple text document, pdf, excel, image, and the like. The method further includes multiple AI models sequentially interacting with each other.

### BACKGROUND

In recent times data analytics has become an integral part of any organization and with continuous growth in data volumes, organizations are employing various methods for maintaining such data in different forms. Along with digital well-structured data, a huge portion of legacy data is stored even in physical paper format. Also, a large volume of data is maintained in digital form but in different kinds of unstructured format, such as word document, pdf, excel, image etc. To extract information from the paper format or the unstructured format in terms of important business entity and to make it part of business process, a significant manual effort is required. Such manual process is both time -consuming as well as error prone.

In order to extract the information from these documents, various methods have been proposed in the recent years which use AI models such as neural network, fuzzy logic to extract the information from these documents. However, these methods have certain limitations while handling complex information extractions. Such limitations may include, but not limited to, handling volume and different types of unstructured data, reducing error rate, increasing the efficiency of analysis, and working on continuous automated refining of the AI Models.

A US patent application U.S. Pat. No. 9,152,860B2 describes an automated system for character recognition. The reference discloses AI models for regional analyses of a document and determining, based on the analysis, whether or not a desired object (i.e. a character) is present in the analysed region. The system further involves continuous monitoring of business user feedback to improve the accuracy of the results and performing OCR on specific zones/regions of the document.

Further, U.S. Pat. No. 10,318,848B2 describes a method for image classification by AI models. The method involves multiple AI models (i.e. ensemble of AI models) for identifying objects in an image and further classifying the images in ticket analysis and resolution system.

Further, U.S. Pat. No. 9704054B1 describes a method of image classification. The method involves using an ensemble of AI models for object recognition in an image and further image classification.

However, all the above-mentioned algorithms fail to provide an efficient method for information extraction, which can function across a diverse variety of unstructured data in images and documents, provides scalability across different AI models and provides solution to allow user to tutor/train the system. Therefore, there exists a need for a method for information extraction which can efficiently function across different data sources, types, can learn continuously and dynamically adapt as per the user's requirements. Hence, an automated information extraction system has become an absolute necessity for every organization irrespective of business domain.

### SUMMARY

One or more shortcomings of prior art are overcome, and additional advantages are provided through present disclosure. Additional features are realized through techniques of the present disclosure. Other embodiments and aspects of the disclosure are described in detail herein and are considered a part of the present disclosure.

The present disclosure discusses a system for intelligent information extraction from multiple data sources e.g. scanned physical paper document, simple text document, pdf, excel, image etc. The system comprises of a framework with different artificial intelligence models which can be trained and tutored by a user and pre-defined data set. Further, these artificial intelligence models interact sequentially with each other, by providing/outputting results of one model to input of other model, thereby increasing accuracy of data extraction. The framework further comprises modules for updating versions of the artificial intelligence models based on user feedback, wherein the accuracy of the updated versions is compared with the accuracy of previous versions, and the version with better accuracy is automatically deployed. This is a continuous automated process with the feedback getting incorporated dynamically in the system.

In one aspect of the disclosure, a method for cognitive information extraction from multiple sources such as scanned physical paper document, simple text document, pdf, excel, image etc. wherein the method involves configuring an ensemble of artificial intelligence models, comprising a first intelligence model for image/document classification, a second intelligence model for object identification, and a third intelligence model for entity name recognition. These artificial intelligence models interact sequentially with each other, by providing results of one model to input of other model, thereby increasing accuracy of information extraction. The method also involves steps of collecting feedback from a user on the extracted information and updating the artificial intelligence models on the basis of user feedback and further, comparing output of the updated artificial intelligence model version to automatically determine version of the model to be deployed for future information extractions. In this manner, the system is continuously refining.

Foregoing summary is illustrative only and is not intended to be in any way limiting. In addition to illustrative aspects, embodiments, and features described above, further aspects, embodiments, and features will become apparent by reference to drawings and following detailed description.

### BRIEF DESCRIPTION OF DRAWINGS

FIG. 1 is a diagram of the cognitive information mining framework.

FIG. 2 shows different modules in the cognitive information mining framework.

FIG. 3 is a diagram of the components of the ensemble of AI model.

FIG. 4 is a diagram of the ensemble of AI model.

FIG. 5 is a flowchart representing method for information extraction.

### DETAILED DESCRIPTION

In the following detailed description of embodiments of the present disclosure, numerous specific details are set forth in order to provide a thorough understanding of the embodiments of the disclosure. However, it will be obvious to one skilled in art that the embodiments of the disclosure may be practiced without these specific details. In other instances, well known methods, procedures, components, and circuits have not been described in detail so as not to unnecessarily obscure aspects of the embodiments of the disclosure.

References in the present disclosure to “one embodiment” or “an embodiment” mean that a feature, structure, characteristic, or function described in connection with the embodiment is included in at least one embodiment of the disclosure. Appearances of phrase “in one embodiment” in various places in the present disclosure are not necessarily all referring to same embodiment.

In the present disclosure, word “exemplary” is used herein to mean “serving as an example, instance, or illustration.” Any embodiment or implementation of present subject matter described herein as “exemplary” is not necessarily to be construed as preferred or advantageous over other embodiments.

The present disclosure may take form of a hardware embodiment, a software embodiment, or an embodiment combining software and hardware aspects that may all generally be referred to herein as a ‘system’ or a ‘module’. Further, the present disclosure may take form of a computer program product embodied in a storage device having computer readable program code embodied in a medium.

While the disclosure is susceptible to various modifications and alternative forms, specific embodiment thereof has been shown by way of example in drawings and will be described in detail below. It should be understood, however that it is not intended to limit the disclosure to the forms disclosed, but on contrary, the disclosure is to cover all modifications, equivalents, and alternative falling within scope of the disclosure.

Terms such as “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude existence of other elements or additional elements in the system or apparatus.

In following detailed description of the embodiments of the disclosure, reference is made to drawings that form a part hereof, and in which are shown by way of illustration specific embodiments in which the disclosure may be practiced. These embodiments are described in enough detail to enable those skilled in the art to practice the disclosure, and it is to be understood that other embodiments may be utilized and that changes may be made without departing from the scope of the present disclosure. The following description is, therefore, not to be taken in a limiting sense.

The present disclosure relates in general to a system and method of cognitive information extraction from a set of documents. More specifically, systems and methods disclosed herein are directed to a cognitive information mining framework, which extracts information from a diverse set of unstructured data in images and documents with combination of AI and other methods of data extraction.

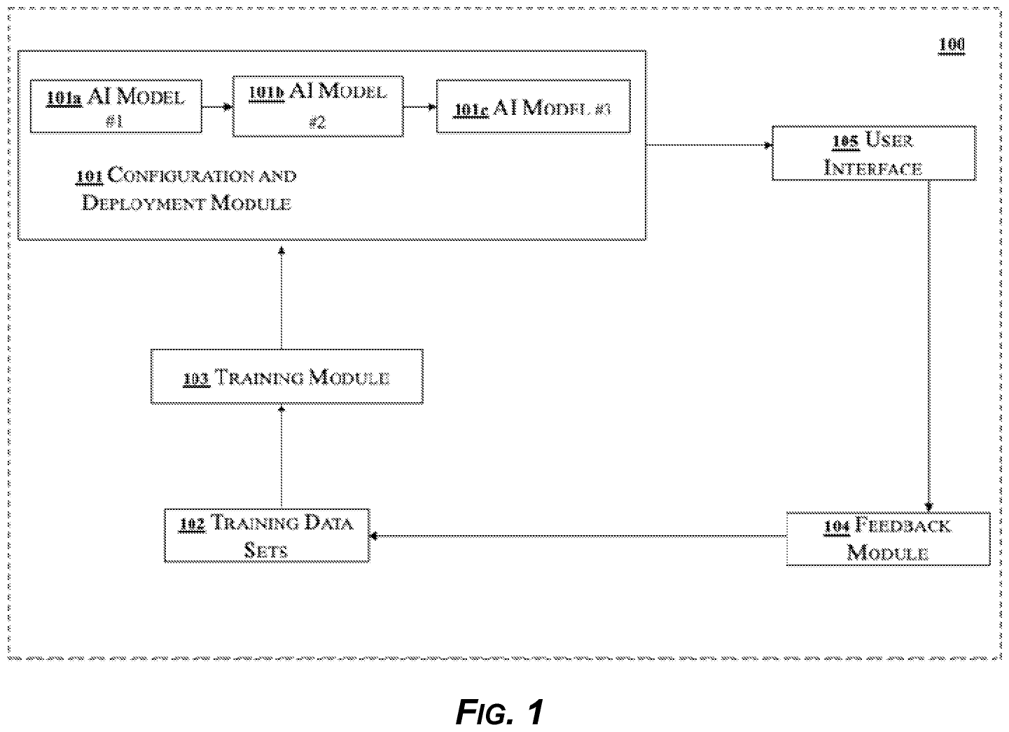

FIG. 1 explains different components of the cognitive information system 100. In embodiments, the system 100 represents a framework and comprises multiple modules. A training data sets module 102 comprises of rules/data including user interests. The rules/data is used by a training module 103 to train different Artificial Intelligence (AI) models (101a, 101b and 101c) present in the Configuration and Deployment Module 101. These models are used to perform functions of identifying objects, classifying documents and recognize entities in a set of documents. A user can upload the documents on the system 100 or create and schedule batches of multiple documents to be uploaded on the system 100. A first AI model 101a classifies a document or an image into a pre-defined category, based on training corresponding to the user interests. A second AI model 101b identifies a region of interest for an object in the document, based on training data corresponding to the user interests. A third AI model 101c interacts with the first AI model 101a to determine a classification category of the document, and determines a relevancy score of the document, and interacts with the second AI model 101b to determine a relevancy score of different regions in the document. Further, the third AI model 101c, processes the document to recognize names of different entities present in the document, if the determined document relevancy score and relevancy of region are above a pre-defined threshold. Steps of processing by third AI models also include image-pre-processing capability to enhance output by applying image enhancement. User interface 105 allows the user to view results of the information extraction and entity identification, and further allows the user to provide feedback. Feedback module 104, collects this feedback and updates the training data sets (i.e. a second training data set is created) basis the feedback. The updated training datasets 102 is then used by the training module 103 to retrain the ensemble of AI models 101 to create a second version of the ensemble of AI models 101. The second version of the AI models is stored in the configuration and deployment module 101. The module 101 further continuously compares accuracy of the updated versions of the ensemble of models, to determine best model version which should be deployed for future processing.

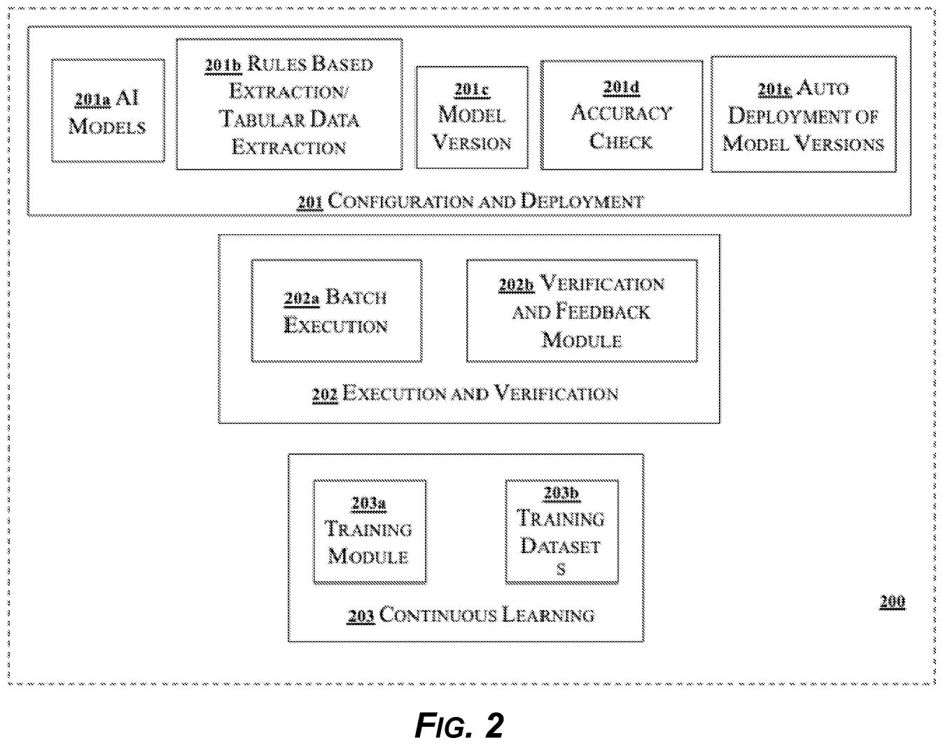

FIG. 2 explains different components 200 present in the cognitive information mining system. A configuring and deployment module 201 includes different AI Models 201a (e.g. Object identification model, document classification model), module for rule based extraction 201b, model version 201c, accuracy check 201d and auto deployment of model versions 201e. The model version module 201c stores different versions of the AI models for future deployment. The accuracy check module 201d checks accuracy of the different versions of the AI models 201a and determines best suited version for future deployment. The auto deployment module 201e, interacts with the accuracy check module 201d, to determine the best suited AI model version, and automatically deploys the determined version. Further present is an execution and verification module 202 comprising a module namely batch execution 202a, which allows the user to run automatic document processing in predefined or scheduled batches. The module 202 also comprises verification and feedback module 202b which allows the user to check/verify a sample of processed documents and provide feedback. Also present is a continuous learning module 203 comprising of a model training module 203a, which is used for retraining the AI models 201a, based on the user feedback. The continuous learning module 203 further comprises training dataset module 203b which is used for training the AI models. Multiple training datasets can be created on basis of the user feedback received from the verification and feedback module 202b.

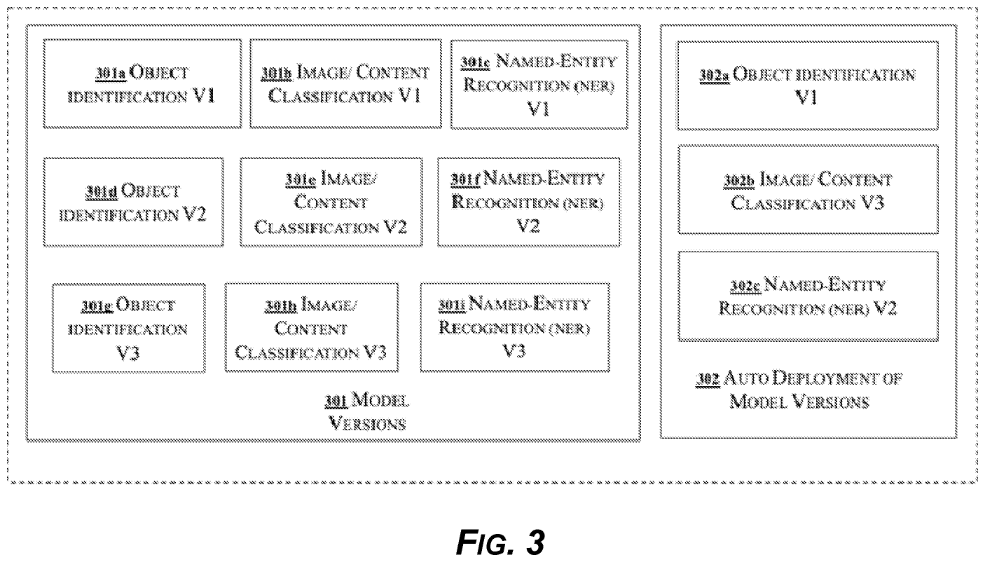

As shown in FIG. 3, 301 includes different versions corresponding to each AI model. In an exemplary case scenario, AI model Object identification has multiple versions 301a, 301d and 301g stored in the system 100. Similarly, AI model for image/content classification has multiple versions such version 1 (V1) 301b, version 2 (V2) 301e and version 3 (V3) 301h. Under same methodology AI model for named-entity recognition (NER) also has multiple versions. Version 1 (V1) is represented by 301c, version 2 (V2) is represented by 301f and version 3 (V3) is represented by 301i. These versions are compared on basis of accuracy. Further, a best suited combination is deployed by auto deployment module 302. In the exemplary scenario shown in the FIG. 3, version 1 (V1) of Object identification AI model 302a, version 3 (V3) of image/content classification model 302b and version 2 (V2) of the named entity recognition model (NER) 302c are deployed by the module 302.

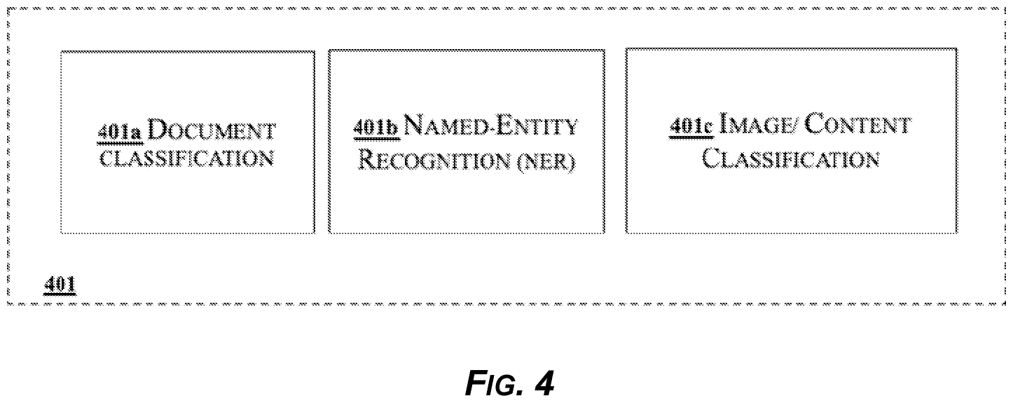

FIG. 4 explains AI models present in ensemble of AI model 401 comprised in the cognitive information mining framework and further included in the system 100. AI model Object identification 401a can identify different objects, patterns, embedded images etc. in a document/image. AI model namely image/content classification 401b classifies images/media content and documents based on identification or presence/absence of different objects, patterns, embedded images etc. in the content/document. AI model named entity recognition (NER) 401c extracts named entities (e.g. Images, embedded files, patterns etc.) from the documents.

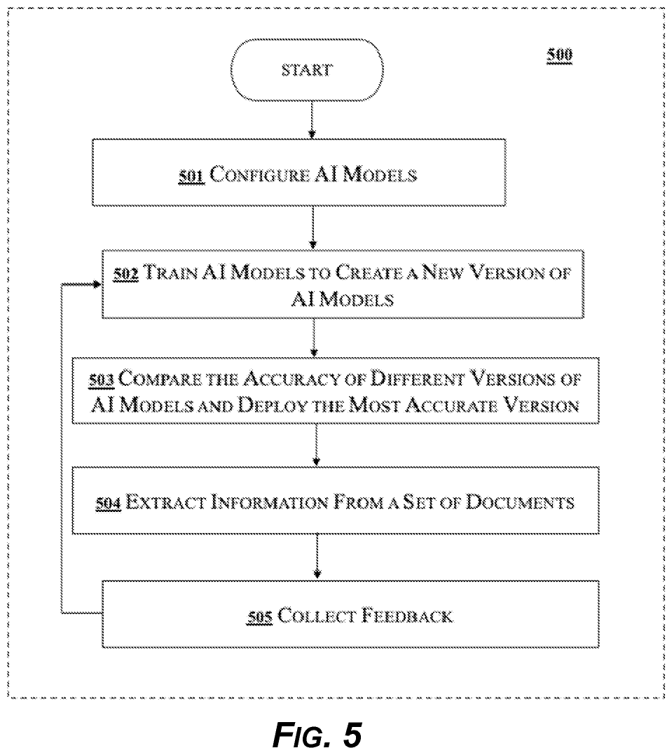

FIG. 5 explains a method of cognitive information extraction 500. At step 501, AI models are configured to perform various operations such as object identification, image/document classification, and entity name recognition. At step 502, the AI models are trained to create a specific version of the trained AI models. At step 503, accuracy of the created version of the AI models is compared with existing versions of the AI models, if any, to determine a best model version which should be deployed. At step 504, the deployed AI model version is used to extract information from a set of documents. At step 505, a user/machine provides feedback on the extracted information. The feedback collected at step 505, is then used to train the models again at step 502. This process is continuously executed to create different versions of AI models, and for automatic deployment of different versions of the AI models.

In the present implementation, the system (100) includes one or more processors. The processor may be implemented as one or more microprocessors, microcomputers, microcontrollers, digital signal processors, central processing units, state machines, logic circuitries, and/or any devices that manipulate signals based on operational instructions. Among other capabilities, the at least one processor is configured to fetch and execute computer-readable instructions stored in the memory. The system further includes I/O interfaces, memory and modules.

The I/O interfaces may include a variety of software and hardware interfaces, for example, a web interface, a graphical user interface, and the like. The I/O interface may allow the system to interact with a user directly or through user devices. Further, the I/O interface may enable the system (100) to communicate with other user devices or computing devices, such as web servers. The I/O interface can facilitate multiple communications within a wide variety of networks and protocol types, including wired networks, for example, LAN, cable, etc., and wireless networks, such as WLAN, cellular, or satellite. The I/O interface may include one or more ports for connecting number of devices to one another or to another server.

The memory may be coupled to the processor. The memory can include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

Further, the system (100) includes modules. The modules include routines, programs, objects, components, data structures, etc., which perform tasks or implement particular abstract data types. In one implementation, module includes a display module and other modules. The other modules may include programs or coded instructions that supplement applications and functions of the system (100).

As described above, the modules, amongst other things, include routines, programs, objects, components, and data structures, which perform particular tasks or implement particular abstract data types. The modules may also be implemented as, signal processor(s), state machine(s), logic circuitries, and/or any other device or component that manipulate signals based on operational instructions. Further, the modules can be implemented by one or more hardware components, by computer-readable instructions executed by a processing unit, or by a combination thereof.

Furthermore, one or more computer-readable storage media may be utilized in implementing some of the embodiments consistent with the present disclosure. A computer-readable storage medium refers to any type of physical memory on which information or data readable by a processor may be stored. Thus, the computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

We claim:

1. A method for cognitive information extraction, the method comprising:
configuring an ensemble of AI models, comprising a first AI model for image/document classification, a second AI model for object identification, and a third AI model for entity name recognition, to process a set of documents by extracting information;
obtaining a first training data set, corresponding to each AI model, indicating user interests corresponding to characteristics of desired information to be extracted;
training, the AI models to create a first version of AI models, based on the extracted training datasets, to identify objects, classify documents and recognize entities in the set of documents;
extracting information from a document present in the set of documents, wherein the steps of extraction include:
classifying a document or image into a pre-defined category, based on training corresponding to user interests, by the first AI model;
identifying a region of interest for an object in a document, based on training corresponding to user interests, by the second AI model; and
recognizing an entity, present in a document, by the third AI model, wherein,
the third AI model interacts with the first AI model to determine the classification category of the document, and determines a relevancy score of the document;
the third AI model interacts with the second AI model to determine a relevancy score of different regions in a document;
the third AI model, processes the document to recognize names of different entities present in the document, if the determined document relevancy score of the document and relevancy of region are above a pre-defined threshold; and
collecting feedback from the user on the extracted information, and updating the AI models, wherein the updating comprises:
creating a second training dataset corresponding to each AI model on the basis of user feedback;
training, the AI models, based on the second training datasets, to create a second version of the AI models;
comparing the output accuracy of the first and second version of the AI model to automatically determine the version of the model to be deployed for information extraction; and p1 continuously comparing and updating the versions of AI model for automatic deployment.

2. The method as claimed in claim 1, wherein the document can be a jpeg, pdf, TIFF, XLS, PNG, word document file.

3. The method as claimed in claim 1, wherein user interests can correspond to a specific image, pattern, document context, logical sections, embedded images etc.

4. The method as claimed in claim 1, wherein the entities can correspond to an object, text (e.g. policy number, start date, price, age group etc.), image patterns etc.

5. The method as claimed in claim 1, wherein the step of extracting information also includes the steps of rules-based extraction to extract information based on pre-defined rules.

6. The method as claimed in claim 1, wherein the cognitive information extraction method can be executed by continuously processing the documents for automatic execution and scheduling.

7. A system for cognitive information extraction, the system comprising:
an ensemble of AI models, comprising, a first AI model for image/document classification, a second AI model for object identification, and a third AI model for entity name recognition, to process a set of documents by extracting information;
a module for obtaining a first training data set, corresponding to each AI model, indicating user interests corresponding to characteristics of desired information to be extracted;
a training module for training the AI models to create a first version of AI models, based on the extracted training datasets, to identify objects, classify documents and recognize entities in the set of documents;
the ensemble of AI models extracting information from a document present in the set of documents, wherein the steps of extraction include:
classifying a document or image into a pre-defined category, based on training corresponding to user interests, by the first AI model;
identifying a region of interest for an object in a document, based on training corresponding to user interests, by the second AI model; and
recognizing an entity, present in a document, by the third AI model, wherein,
the third AI model interacts with the first AI model to determine the classification category of the document, and determines a relevancy score of the document;
the third AI model interacts with the second AI model to determine a relevancy score of different regions in a document;
the third AI model, processes the document to recognize names of different entities present in the document, if the determined document relevancy score of the document and relevancy of region are above a pre-defined threshold; and
collecting feedback from the user on the extracted information; and
updating the AI models, wherein the updating comprises:
creating a second training dataset corresponding to each AI model on the basis of user feedback;
training, the AI models, based on the second training datasets, to create a second version of the AI models;
comparing the output accuracy of the first and second version of the AI model to automatically determine the version of the model to be deployed for information extraction; and
continuously comparing and updating the versions of AI model for automatic deployment.

8. The system as claimed in claim 7, wherein the document can be a jpeg, pdf, TIFF, XLS, PNG word document file.

9. The system as claimed in claim 7, wherein user interests can correspond to a specific image, pattern, document context, logical sections, embedded images etc.

10. The system as claimed in claim 7, wherein the entities can correspond to an object, text (e.g. policy number, start date, price, age group etc.), image patterns etc.

11. The system as claimed in claim 7, wherein the step of extracting information also includes the steps of rules-based extraction to extract information based on pre-defined rules.

12. The system as claimed in claim 7, wherein the system continuously processes the documents for automatic execution and scheduling of cognitive information extraction.
